(19) United States
(12) Patent Application Publication
(10) Pub. No.: US 2008/0261323 A1
(43) Pub. Date: Oct. 23, 2008

(54) Photo-Swichable Surfaces with Controllable Physico-Chemical Properties

(76) Inventors: Dermot Diamond, Dublin (IE); Robert Byrne, Dublin (IE); Shannon Stitzel, Saratoga Springs, NY (US)

Correspondence Address: BROWN RUDNICK LLP, ONE FINANCIAL CENTER, BOSTON, MA, 02111, US

(21) Appl. No.: 12/065,667

(22) PCT Filed: Sep. 6, 2006
(86) PCT No.: PCT/US06/34532

§ 371 Date: May 9, 2008

Related U.S. Application Data
(60) Provisional application No. 60/714,398, filed on Sep. 6, 2005.

(51) Int. Cl. G01N 21/77

(52) U.S. Cl. 436/166

(57) ABSTRACT

Photochromic materials, such as spiropyran dyes, are disclosed that can be used for high-density optical storage and molecular switches. According to the disclosure these compounds can be used as transducers in optical sensors. When the spiropyran dye absorbs UV light it switches to the merocyanine form, and this structure has an active binding site for cations. When cations bind to the site, the resulting colored complex has a new absorption band in the visible spectrum. By shining white or green light on the colored complex, the dye is reverted to the closed spiropyran form, and the cation is released. The disclosure optimizes the immobilization of the spiropyran dye onto a polymer substrate via long chain alkyl groups. These long chain alkyl linkers enable the dye to reversibly form the preferred merocyanine (2):(1) cation sandwich complex.

### FIELD OF INVENTION

The present invention relates to chemical sensing. In particular the invention relates to chemical sensing using photo-switchable membrane based sensors.

### BACKGROUND OF INVENTION

Developments in chemical sensing over the last couple of decades have essentially been incremental, with little in the way of fundamental rethinking of the ‘chemical sensing’ process. And while there have been some major advances in the theory of membrane based sensors, such as very low limits of detection through the control of ion fluxes through membranes, the actual measurement process has remained unchanged.

Essentially, chemical sensor measurements involve molecular recognition or transduction. In molecular recognition the sensor typically contains immobilised chemo-recognition agents (e.g. ligand) that selectively bind with a particular target species in a sample, and ideally does not bind with other ‘interfering’ species that may be present in the sample matrix. The binding behavior of the surface/membrane should remain constant and predictable over time.

In chemical sensing, the molecular binding event is transduced into an electronic or optical signal that can be monitored externally. The sensor may therefore have specific molecular transducers (e.g. chromophores, fluorophores or redox agents) co-immobilised with the recognition agent (or built into the molecular structure of the recognition agent), or the binding event inherently generates a signal (e.g. in potentiometry, perm-selective binding of ions leads to the generation of an interfacial potential).

In prior art approaches, the molecular recognition and transduction agents are immobilised within a membrane or on an active surface, and this is exposed to the sample. Accurate measurements require calibration, due to the fact that sensor surfaces/membranes are ‘active’ i.e., they must interact chemically with the sample to generate a signal and be in intimate contact with the sample to generate the signal, unlike physical transducers such as thermistors that can be completely encapsulated in a protective coating (e.g., epoxy), which nonetheless does not interfere with their ability to function.

Unfortunately, chemical sensors must be regularly recalibrated for accurate measurements as the surface and bulk characteristics change with time due to various interactions with samples. For example, active components may leach out into the sample, chromophores may become photo-bleached, or surfaces may become fouled. The need for calibration means that the sensing surface must be regularly removed from the sample and exposed to usually two or more reagents that ideally mimic closely the matrix of the sample and contain differing concentrations of the target species. Calibration thus enables the response slope and intercept to be re-estimated (for non-linear responses, more that two calibrants are required), and experimental signals to be more accurately related to the unknown concentrations.

This calibration procedure is used almost uniformly for chemical sensor measurements. However, from the above outline it is clear that autonomous field deployable sensors must incorporate a calibration regime, and the instruments are therefore relatively expensive and complex, as they must incorporate the necessary reagents, pump, valves, power, electronics and self-diagnostics required ensuring that the device is functioning properly. Consequently, chemical sensors (and similarly, biosensors) in their current manifestation described above, are too complex and expensive to be field deployed in large numbers. Hence these devices are almost completely ignored in the emerging area of ‘sensor-nets’ (i.e., deployments of wireless networks of sensing devices) and it is difficult to imagine how the current technology can be scaled up to the numbers involved in wide-area distributed monitoring.

### SUMMARY OF THE INVENTION

Accordingly, to overcome the disadvantages and drawbacks of the prior art, a method of chemical sensing is provided that utilizes photo-switchable sensing surfaces that are activated by a selected wavelength range and deactivated by an additional selected wavelength range. According to the disclosure this sensing surface does not need calibration.

According to the disclosure a colorimetric sensor based on covalent immobilization of spiropyran dyes onto polymeric substrates is disclosed. The sensor surface is a photo responsive film whose activity is controlled by exposure to different wavelengths of light. When the sensor is in its passive state, it cannot interact with an analyte of interest such as metal ions. However, activation of the sensor by exposure to UV light enables the spiropyran dye to open and sense the presence of an analyte of interest.

Prior art methods are restricted to solution phase possibly due to the difficulty in retaining the open form of spiropyrans within a non-polar membrane due to its zwitterionic nature, and inhibition of the formation of a 2:1 receptor-ion molecular ‘sandwich’ because of reduced flexibility of surface-bound receptor molecules. According to the disclosure a rather long 8-methylene linker chain provides the necessary degree of flexibility, and facilitates the formation of the 2:1 sandwich arrangement with surface bound receptors. It is contemplated within the scope of the disclosure that the linker can be of varying lengths and molecular configurations.

In one aspect of the disclosure metal binding behavior and surface reactivity of the sensor surface is externally controlled using photons of particular selected wavelengths. Covalent attachment of the receptor-dye allows a rugged, solid-state sensor format to be made which will be advantageously inexpensive to manufacture.

According to one illustrative embodiment, spiropyran dye is covalently linked to a polymeric substrate using a linker that provides sufficient flexibility for the sandwich complex to be effectively formed. All prior art approaches have been restricted to glass surfaces and previous metal ion complexation experiments have been in solution phase. The concept of inactive-active form switching combined with detection of metal ions on a solid support has not been described or realized previously.

According to an aspect of the current disclosure, the sensing surface is populated with inactive species when a measurement is not being conducted.

In a further aspect of the current disclosure, the sensing surface is converted into an active form under an external stimulus. In an illustrative embodiment the external stimulus in an optical wavelength in the UV range produced by a light emitting diode. It is contemplated within the scope of the disclosure that the optical wavelength can be selected wavelength or range of wavelengths produced by flash-lamps, lasers or the like.

In yet another aspect of the current disclosure, the active sensing surface binds with a target and generates a signal that enables the analytical measurement to be made. In a first illustrative embodiment this signal is generated by a change in colour (i.e. shift in visible spectrum if the metal ion binds to the surface active sites). According to the disclosure, after the measurement is completed, the guest species is expelled by an external stimulus (optical—green LED) and the surface returns to its inactive form.

It is contemplated that sensing surfaces according to the disclosure could be used various chemical sensing applications such as environmental monitoring and early warning systems.

It is further contemplated according to the disclosure that user controlled sample enrichment or sample cleanup—surface interaction of dissolved components can be controlled.

In a further aspect of the disclosure, nano-switches that can be operated under opto and/or chemo control are envisioned. In an illustrative embodiment, opening the switch to the active form in the presence of a metal ion will result in a different final state (colour) to opening in the absence of the metal ion. Photo-switching can also be chemo-controlled through variation of the molecular environment or chemical state of the spiropyrans molecule. For example, at low pH the active form becomes protonated at the negative phenoxy binding site, and this will drastically inhibit metal-ion binding.

In a further illustrative embodiment a spiropyran derivative is covalently immobilized to a polymer (PMAA) surface which can interact with metal ions under external control. The formation of the modified polymer creates a photo-switchable surface capable of capture and release of metal ions using LEDs to trigger the conversion of the spiropyrans between its inactive and active forms. The active form is highly conjugated and absorbs strongly in the visible spectrum (purple colour) whereas the inactive form is colourless. According to the disclosure, binding with metal ions causes a shift in the absorbance spectrum of the active form.

In another illustrative embodiment a photo-switchable surface is formed using a spiropyran derivative immobilized to a polymer (PMAA) substrate to detect metal ions optically. The switching from the inactive to the active form on a plastic substrate is accomplished using a UV-LED (λₘₐₓ=380 nm). The switching from the active to the inactive form on a plastic substrate is accomplished by using a Green LED (λₘₐₓ=564 nm). The ejection of the guest metal ion from the active site and return to inactive form is accomplished using a green LED.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1A is a Job's plot of spiropyran and CoCl₂ complex in acetonitrile, establishing the 2:1 stoichiometry of the receptor-metal ion complex;

FIG. 1B depicts a schematic representation of the spiropyran and CoCl₂ sandwich complex. The spiropyran in the inactive closed (uncharged, neutral) form (left) is converted into the active open (zwitterionic) form (centre) by UV-LED;

FIG. 2 graphically depicts the UV visible spectrum of covalently immobilized spiropyran on a PMAA surface using different tether lengths;

FIG. 3 graphically depicts the UV Visible spectrum of 8C spiropyran film exposed to CoCl₂ multiple times (error bars representation of standard deviation when n=3);

FIG. 4 displays UV LED activation of a PMMA-PMAA-NH-SP film (90 sec) from the closed to open form of the dye, showing use of a simple mask (Adaptive Sensor Group logo) to control the spatial distribution of the photochemical ring-opening effect;

FIG. 5 is a schematic depiction of an illustrative embodiment according to the disclosure; and

FIG. 6 is a photograph of a spiropyran film exposed to a) 1×10⁻² M solution of CoCl₂ in ethanol and b) ethanol only.

### DETAILED DESCRIPTION OF THE EXEMPLARY EMBODIMENTS

Detailed embodiments of the present disclosure are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

The open mercyanine forms of spiropyrans have long been known to complex with metal ions in organic solvents, leading to a change in the visible region of the dye's absorbance spectrum. This metal ion/spiropyran complex has also been seen in solution studies. However, the ability of the dye to complex with metal ions when immobilized on a solid support has not previously been demonstrated.

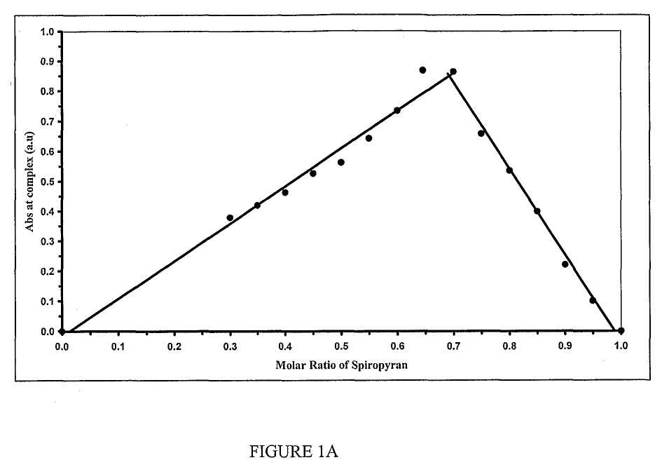

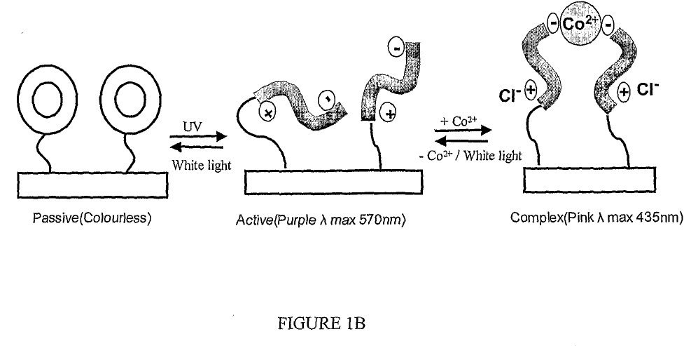

As shown in FIG. 1A, it has been determined that the spiropyran/Co²⁺ complex is about 2:1 ratio in acetonitrile. Without being bound to any particular theory, it is assumed that a similar ratio is necessary to form the complex when the spiropyran is covalently immobilized on a surface. Through monitoring the absorbance spectrum of the immobilized dye, it was determined that the length of the diamino linker used to attach the dye to the surface dramatically affects the ability of the covalently immobilised dye to complex with free metal ions in solution. If the tether length is too short, the dye molecules do not have enough mobility to complex with metal ions, and the surface density of coverage is reduced, possibly by the steric effect of the rather bulky spiropyrans ring system.

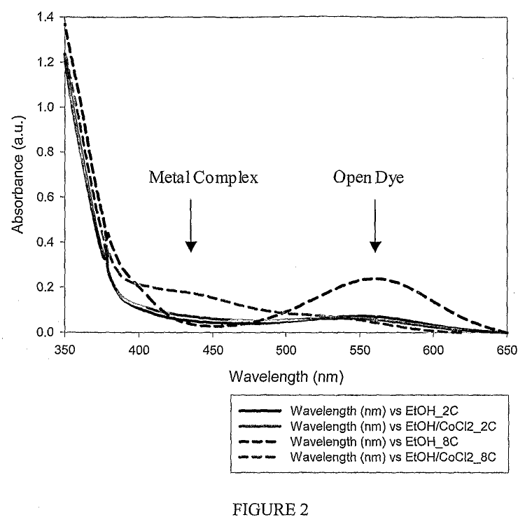

By increasing the tether length, the immobilized spiropyran molecules are much more mobile, and the surface density appears to be increased (active dye absorbance is significantly increased compared to shorter tether lengths for equivalent experiments), and the efficiency of complexation of the metal ions, which is schematically depicted in FIG. 1B, is dramatically improved. For example, FIG. 2 graphically compares the spectra from two different films, one with a short 2-carbon linker and one with a long 8-carbon linker, in equivalent experiments. The film made with the short linker has a weak open dye peak at about 570 nm, and there is very little change in the spectrum upon exposure to Co²⁺ solution. In contrast, the 8-carbon linker film has a strong open dye peak in ethanol, and then exposure to the metal solution leads to a large reduction of absorbance at 570 nm, and the emergence of new peak at approximately 435 nm due to the dye complexing with the Co²⁺ metal ion.

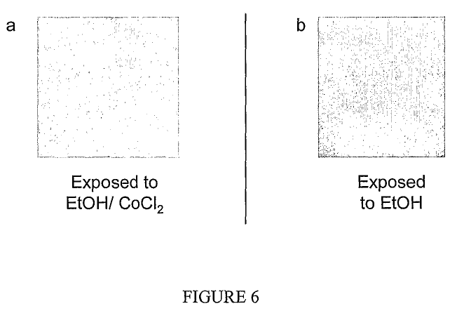

The activated 8-carbon linker films display a distinct colour change upon exposure to Co²⁺ ions in ethanol solution. The change in the colour of the polymer film is seen in FIG. 6, where the film exposed to the metal solution is pink vs. the film only exposed to ethanol which is a dark purple colour. The change in colour could be used as a quick and easy visual indicator of the presence or absence of a metal in solution.

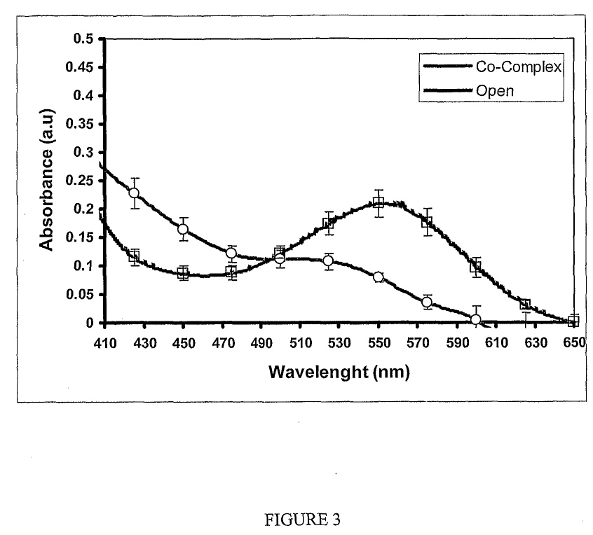

As shown in FIG. 3, this metal complex can be formed, released and reformed on a polymer surface multiple times. The metal is released from the film by washing in water while exposing the film to white light (or a green LED), which leads to regeneration of the closed (inactive) spiropyrans. This demonstrates that a sensor based on this technology would be reusable using photonics to control the surface chemistry rather than reagents.

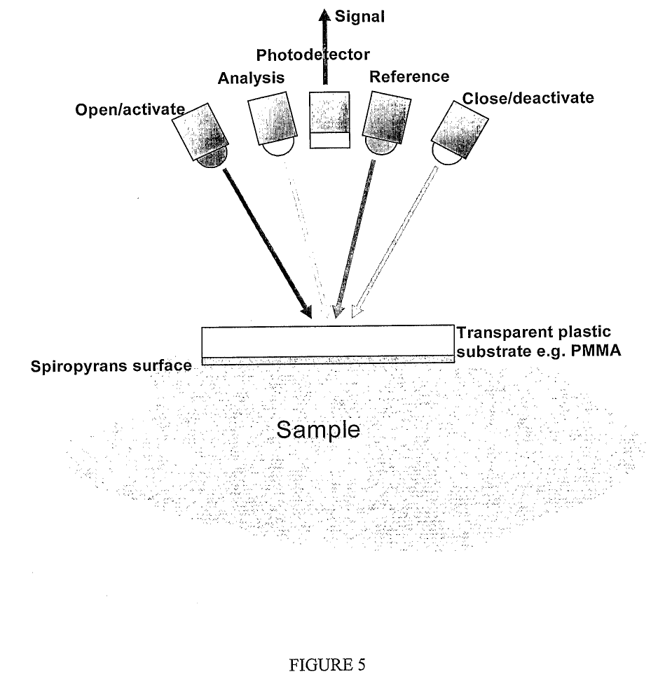

Turning to FIG. 5, a possible format for a sensing device 500 according the disclosure is depicted. The sensing device 500 has a series of LEDs 502 arranged to provide surface activation, analytical measurement, reference measurement, and surface deactivation using a backscatter approach is shown. A photo detector 504 is employed to monitor a backscatter signal 506. This illustrative embodiment has the advantage of not being affected by turbidity or colour changes occurring in a sample 508. Other configurations are possible according to the invention including transmission measurements (through the sample) and coating LEDs with the polymer film.

According to the invention, ‘adaptive sensors’ that can adapt their functionality through reversible molecular rearrangements triggered by external stimuli (photons) can be formed. It is contemplated within the scope of the invention that immobilised chemo-recognition sites can be maintained in an inactive or passive form until a measurement is required (colourless). At this point, the surface can be illuminated with UV-photons (UV-LED), which triggers the molecular rearrangement into the active form (purple). The sensing surface, according to the disclosure, is self-indicating, as the presence of the active form is easily identified via the intense purple colour. Binding with metal ions (e.g. Co²⁺) can occur, and once again it is self-indicating, as complexation shifts the absorbance of the active site and the colour changes to pink. Once the measurement has been completed, illumination with a green LED expels the guest ion and returns the site to the inactive form.

Without being bound to any particular theory, it appears that spiropyrans binds Co²⁺ in a 2:1 sandwich-type complex, and obtaining efficient ion binding from a covalently immobilised ligand is not easy to achieve, as immobilisation drastically restricts molecular flexibility, and therefore inhibits the formation of the sandwich complexes. According to the disclosure a relative long C8 tether is required, along with rather dense coverage of the surface to enable nearby sites to efficiently sandwich the metal ion and produce effective binding. It is contemplated within the scope of the disclosure that tether of varying lengths and molecular composition can be used.

It is contemplated within the scope of the invention that it is possible to maintain a sensing surface in a passive mode that does not interact significantly with the external environment. When a measurement is required, the active form is created (and the population monitored via the development of the purple colour). The presence of the target species can then be measured by ratioing the absorbance at about 435 nm and about 570 nm. A decrease at about 570 nm (λₘₐₓ of the free ‘active’ form) with an accompanying increase at about 435 nm (λₘₐₓ of the Co²⁺ complex) is indicative of the presence of a metal ion such as Co²⁺. This allows having sensing surfaces that do not change characteristics in a significant manner over time, which in turn allows calibration-free chemical sensors. The self-indicating nature of the spiropyrans is a simple but yet robust feature which provides a measure of self-diagnostics and internal referencing of analytical measurements.

In contrast to the closed uncharged form, the open (active form) is zwitterionic, and is therefore very soluble in polar solvents, leading to significant leaching of the receptor dye from such membranes. The covalent attachment prevents leaching of active sites into a sample, a process that does occur readily with non-bound spiropyrans entrapped within a thick plasticized non-polar membrane. Using this approach, according to the disclosure it is possible to realize very low cost but reliable chemical sensors that can be scaled up for wide area deployment in chemo-sensor nets. In one illustrative embodiment, a simple arrangement would have the spiropyrans covalently immobilised on an optically transparent substrate such as PMMA, and to use an array of LEDs coupled with a photo detector to interrogate the film. It is contemplated within the scope of the invention that various polymeric substrates can be used.

### Example I

### Synthetic Make Up of Spiropyran with Carboxylic Acid Handle

In a first illustrative embodiment, a spiropyran, 1′-(3-Carboxypropyl)-3′,3′-dimethyl-6-nitrospiro[2H-1]-benzopyran-2,2′-indoline is produced in a three-step sequence beginning with the preparation of the desired indoline as the quaternary ammonium salt. The salt formation is followed by an aldol type of condensation of equimolar amounts of the quaternary salt of 1′-(3-Carbomethoxypropyl)-3′,3′-dimethyl-2-methyleneindoline and 5-nitrosalicaldyhyde to give the corresponding 1′-(3-Carbomethoxypropyl)-3′,3′-dimethyl-6-nitrospiro[2H-1]-benzopyran-2,2′-indoline. This intermediate then undergoes base-induced ester hydrolysis to give the required carboxylic acid handle on the spiropyran dye (SPCOOH).

### Structure of 1′-(3-Carboxypropyl)-3′,3′-dimethyl-6-nitrospiro

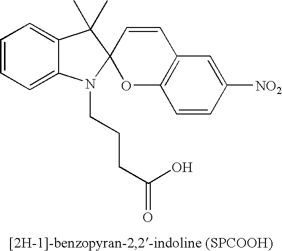

### Example II

### UV Photo-polymerization of Methacrylic Acid onto a PMMA Substrate

A polymethylmethacrylate (PMMA) substrate, about 0.5 mm thick, was thoroughly cleaned by immersing in about 50:50 ethanol/water solution for about 30 minutes, followed by rinsing with a large excess of deionised water. Methacrylic acid was distilled at about 50° C. under reduced pressure to remove inhibitors. The PMMA substrate was placed in a spin coating chamber and the surface covered with a monomer solution containing methacrylic acid and about 1% (w/w) of the photo-initiator omega, omega-dimethoxy-omega-phenylacetophenone, (DMPA).

The solution was allowed to absorb onto the PMMA substrate for about 5 minutes and then excess monomer was removed by spinning at about 1000 rpm for about 5 seconds. The PMMA substrate was subsequently removed from the spin coater chamber and photo-polymerization was carried out in UV curing chamber at a distance of about 10 cm from an about 280 nm UV light source for about two hours at room temperature. A polymethacrylic acid (PMAA) thin film was generated during this polymerization, yielding a polymer substrate with a carboxylic acid functionalized surface. The PMAA coated substrate (PMMA-PMAA) was then washed in deionised water for about two hours and dried under nitrogen stream.

### Example III

### Immobilization of Spiropyran onto Polymer Surface via 1,8 diamino octane

The PMMA-PMAA substrate, produced in Example II, was further modified as shown in the reaction scheme, set forth below for the covalent immobilization of spiropyran onto a PMAA surface via diamino alkyl groups. The PMMA-PMAA was immersed in a 1.5 mg/ml solution of 1-ethyl-3-(3-dimethylamino propyl) carbodiimide hydrochloride (EDC) in deionised water for about 20 minutes, followed by the addition of 1,8-diamino octane (7.5 mg/ml). The mixture was allowed to stir for about 24 hours at room temperature to yield an amine-terminated polymer surface (PMMA-PMAA-NH₂).

The amine-coated substrate was washed in a 50:50 ethanol/water solution for 30 minutes to remove unbound 1,8-diamino octane, and then rinsed with deionised water and dried under nitrogen stream. A 3:1 solution of deionised water and ethanol containing EDC (1.5 mg/ml) and SPCOOH (2.5 mg/ml) was allowed to stir at room temperature for about 20 minutes. The PMMA-PMAA-NH₂ substrate was then added to this solution and allowed to stir for about 36 hours at room temperature. During this thirty-six hour period it was important to protect the reaction from light in order to minimize photo-degradation of the dye. The reaction yielded a polymer substrate with a spiropyran dye covalently attached to the surface (PMMA-PMAA-NH-SP). The spiropyran-coated substrate was removed and washed in a 50:50 ethanol/water solution for about 30 minutes to remove unbound SPCOOH. The film was then washed with copious amounts of deionised water and dried under nitrogen stream. The PMMA-PMAA-NH-SP substrate was stored in the dark.

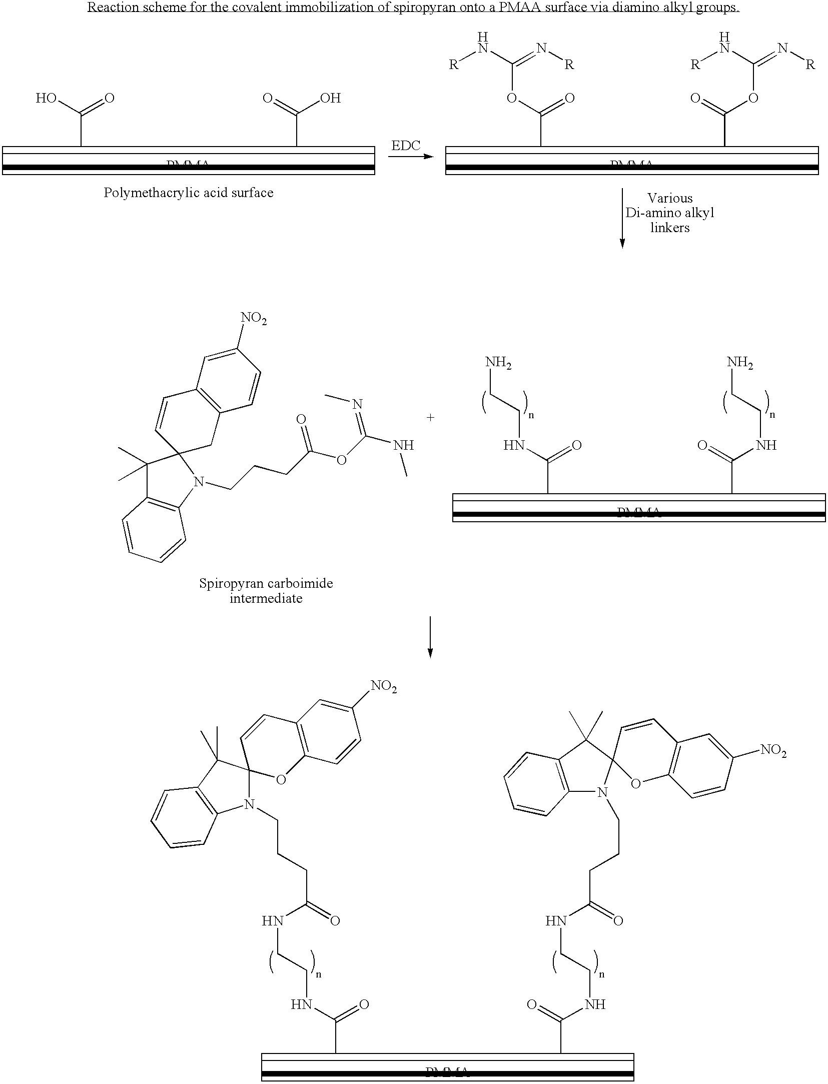

### Example IV

### Metal Detection with Spiropyran Immobilized Polymer Films

A PMMA-PMAA-NH—SP film produced in Example III was irradiated with a Bondwand® at 365 nm for one minute to open the spiropyran. The purple film was then placed in a quartz cuvette containing 1×10⁻² M CoCl₂ in Ethanol. The film was left exposed to the metal solution in the dark for about 1 minute and then the absorbance spectrum was recorded with a UV visible spectrometer. The metal was released from the film by washing with water under white light irradiation for about 1 minute.

### Example V

### Use of LED Light Sources to Open and Close Spiropyran Films

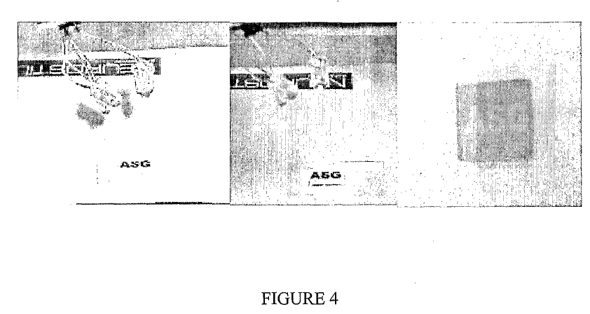

Another aspect of the disclosure is the use of LED light sources as alternative means to activating the opening/closing mechanism of the spiropyran films. In this Example it was demonstrated that films with the dye entrapped within the PMAA matrix can be reversibly switched over 100 times using a 380 nm UV LED to open the dye and 564 nm green LED to closed the dye. These same LEDs have also proven effective with the covalently immobilized dye films discussed herein. FIG. 4 shows that under UV LED illumination a spot on an 8-carbon linker film can be activated (purple colour) with a few minutes exposure. This photograph also demonstrates the ability to pattern the films using masks with the light source.

Although the disclosure suggests the use of the invention in low cost widely deployed chemo-sensors in sensor networks that are calibration free devices, it should be appreciated by those skilled in the art that sensing surfaces with photonically switchable surface energy, colour, charge (polarity), can be used to produce ‘smart’ separation systems capable of sequestering ions and releasing them depending on the surface form. Likewise it will be appreciated that the sensing surfaces according to the invention can be employed for pre-concentration of ions in solution at a surface (e.g. to concentrate a desirable species from a matrix, or to strip out an undesirable component from a matrix). Furthermore, it will be appreciated that the sensing of non-metal ions or other compounds of interest can be accomplished according to the disclosure.

While the disclosure has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims.

What is claimed is:

1. A method of chemical sensing comprising the steps of
immobilizing a spiropyran dye onto a polymeric substrate forming a photo responsive sensing surface,
exposing said photo responsive sensing surface to a light source causing said spiropyran dye to become receptive to an analyte of interest,
reacting a sample with said photo responsive sensing surface, and
observing the presence of said analyte of interest.

2. The method according to claim 1 wherein said spiropyran dye is covalently linked to said polymeric substrate using a linker that provides sufficient flexibility for the sandwich complex to be effectively formed.

3. The method according to claim 2 wherein said linker is long chain alkyl linker.

4. The method according to claim 1 wherein said spiropyran dye absorbs light causing said spiropyran dye to convert to a reactive merocyanine structure.

5. The method according to claim 4 wherein said merocyanine structure has an active binding site for cations.

6. The method according to claim 1 wherein said selected wavelength range is in the ultraviolet range.

7. The method according to claim 5 wherein said active binding site when bound by cations results in a colour complex having a selected absorption band.

8. The method according to claim 7 wherein said selected absorption band is in the visible spectrum.

9. The method according to claim 1 wherein at least one said sensing surface forms a sensor network.

10. The method according to claim 1 wherein said sensing surface can be used to measure the concentration of ions in contact with said surface.

11. The method according to claim 1 wherein said sensing surface can be used as nano-switches.

12. The method according to claim 1 wherein said light is a selected wavelength.

13. The method according to claim 12 wherein said selected wavelength is generated from light emitting diodes.

14. The method according to claim 12 wherein said selected wavelength is generated from a laser.

15. The method according to claim 1 wherein said light is a selected wavelength range.

16. The method according to claim 15 wherein said selected wavelength range is generated from flash-lamps.
